(19) United States
(12) Patent Application Publication
(10) Pub. No.: US 2018/0172013 A1
(43) Pub. Date: Jun. 21, 2018

(54) MOTOR AND A HANDHELD PRODUCT HAVING A MOTOR

(71) Applicant: Dyson Technology Limited, Wiltshire (GB)

(72) Inventors: Nigel Youatt DYMOND, Swindon (GB); Alan Glynn SANDERSON, Old Basing (GB); Benjamin Christopher MERCER, Bristol (GB)

(73) Assignee: Dyson Technology Limited, Wiltshire (GB)

(21) Appl. No.: 15/847,165

(22) Filed: Dec. 19, 2017

(30) Foreign Application Priority Data
Dec. 20, 2016 (GB) 1621710.1

(51) Int. Cl. F04D 25/06; F04D 29/32; F04D 29/38; H02K 7/14; A45D 20/12

(52) U.S. Cl. CPC F04D 25/0606; F04D 29/329; F04D 29/542; H02K 7/145; A45D 20/12; F04D 29/388

(57) ABSTRACT

A motor comprising a frame for supporting a rotor assembly and a stator assembly, the frame comprising an inner wall and an outer wall and a plurality of diffuser vanes extending between the inner wall and outer wall; a rotor assembly comprising a shaft, a magnet, a bearing assembly and an impeller; and a stator assembly comprising a bobbin, a stator core and a winding wound round the bobbin; the impeller comprising a metal hub and an outer portion, the outer portion comprising a plurality of blades and being formed of plastic or carbon fibre composite.

### REFERENCE TO RELATED APPLICATIONS

This application claims the priority of United Kingdom Application No. 1621710.1, filed Dec. 20, 2016, the entire contents of which are incorporated herein by reference.

### FIELD OF THE INVENTION

The present disclosure relates to a motor and a handheld product comprising a motor.

### BACKGROUND OF THE INVENTION

When developing a handheld product, it is important to consider a number of factors that will affect the end-user. For example, the size and weight of the product must be kept down in order that a user is able to handle the product easily, and that the product does not cause discomfort to the user during use. Another important consideration is that of noise. It is preferable that a handheld product does not produce a level of noise that is unpleasant and/or uncomfortable during use. What is more, excessive noise could potentially be damaging to a user's hearing if the product is used regularly over a long period of time. It is often the case that additional soundproofing, for example foam, is included in a product in order to maintain an acceptable level of noise generated by the product. Alternatively, the motor can be run at a lower power to reduce the level of noise that it generates. Of course, neither of these solutions are particularly desirable. Additional components or materials such as foam will increase the cost of the product, and running the motor at a lower power will negatively affect the performance of the product.

In handheld products which contain motors, it is often the motor that contributes the most towards the weight of the overall product and also towards the noise of the product during use.

### SUMMARY OF THE INVENTION

Embodiments of the disclosure provide a motor comprising a frame for supporting a rotor assembly and a stator assembly, the frame comprising an inner wall and an outer wall and a plurality of diffuser vanes extending between the inner wall and outer wall; a rotor assembly comprising a shaft, a magnet, a bearing assembly and an impeller; and a stator assembly comprising a bobbin, a stator core and a winding wound round the bobbin; the impeller comprising a metal hub and an outer portion, the outer portion comprising a plurality of blades and being formed of plastic or carbon fibre composite.

The motor therefore includes an impeller that may be manufactured in a simple and/or cost effective manner.

In some embodiments, the metal hub includes a cylindrical portion. The metal hub includes a portion of greater radius than the cylindrical portion. This arrangement may allow these portions to be tuned such that a desired mass and/or moment of inertia of the impeller can be easily achieved.

In some embodiments, the portion of greater radius is generally disc-shaped. The portion of increased radius may include an axial protrusion. The axial protrusion is annulus-shaped. As such, the axial protrusion may increase the surface area of bonding between the metal hub and the outer portion, and/or may constrain the expansion of the outer portion at high speeds and increase the bond strength between the two parts.

The outer portion may include an outer hub that radially surrounds at least part of the metal hub.

The impeller may be an axial impeller.

The impeller may be relatively lightweight compared to other impellers that may be formed for example entirely from brass or other metal. In some embodiments, the frame is formed from zinc by one or a combination of die-casting and machining. The heavy weight of the zinc frame may be offset by the light weight of the impeller.

In some embodiments, the metal hub is formed of brass.

The outer portion may be overmoulded onto the metal hub.

In some embodiments, the impeller comprises 13 blades. Additionally or alternatively, during use, the rotor spins at a speed of between 50 and 120 krpm to generate airflow through the product. The number of blades and/or the rotational speed may cause a portion of the noise produced by the motor in use to be outside of the range of human hearing and thus may contribute to reducing the audible noise of the motor.

The metal hub may include at least one notch into which a part of the outer portion protrudes so as to inhibit axial movement of the outer portion relative to the metal hub.

Embodiments of the disclosure also provide a handheld product comprising a motor as described in any of the preceding paragraphs for generating an airflow through the product. The handheld product may be a hair care appliance.

Embodiments of the disclosure also provide an impeller for a motor, the impeller comprising a metal hub and an outer portion, the outer portion comprising a plurality of blades and being formed of plastic or carbon fibre composite.

### BRIEF DESCRIPTION OF THE DRAWINGS

In order that the present disclosure may be more readily understood, embodiments of the disclosure will now be described, by way of example, with reference to the following accompanying drawings, in which:

FIG. 1 is a handheld product in the form of a hair dryer;

FIG. 2 is a cross section through the hair dryer of FIG. 1;

FIG. 3 is an exploded perspective view of a motor;

FIG. 4 shows a cross section through a frame of the motor of FIG. 3;

FIG. 5 shows a cross section through a rotor assembly of the motor of FIG. 3;

FIG. 6 is an axial impeller;

FIG. 7 shows a cross section through a partly assembled motor such as that shown in FIG. 3;

FIG. 8 shows an alternative impeller according to embodiments of the disclosure; and

FIG. 9 shows a cross section of the impeller of FIG. 8.

### DETAILED DESCRIPTION OF THE INVENTION

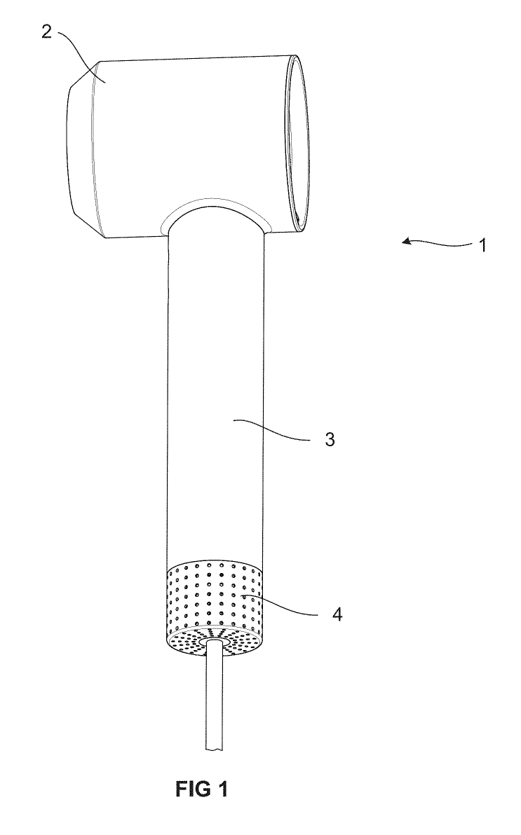

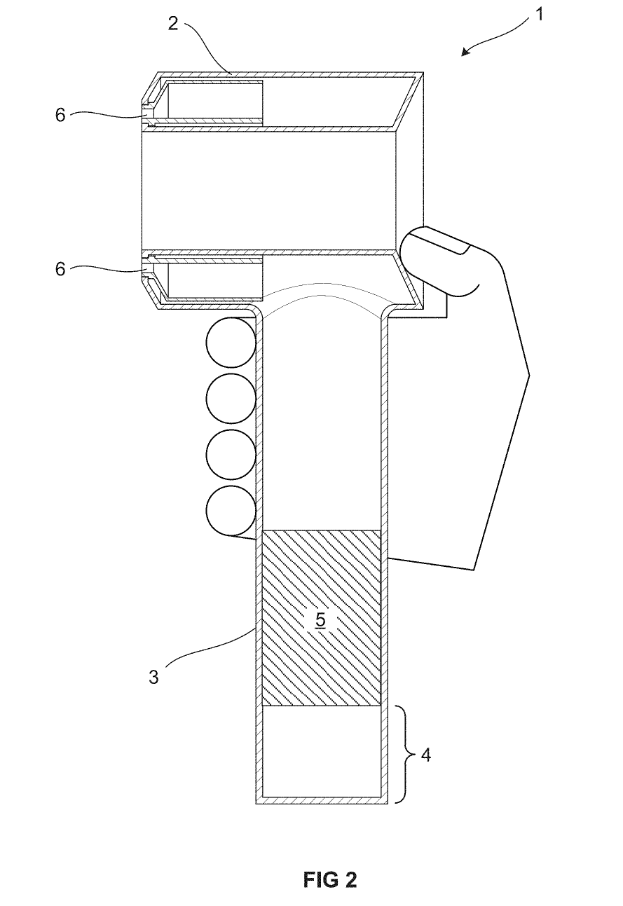

FIGS. 1 and 2 show a handheld product, represented by hair dryer 1. FIG. 2 is a schematic illustration of a cross section through the hair dryer 1. The hair dryer 1 has a body 2 through which air is expelled, and a handle 3 attached to the body 2 by which a user can hold the hair dryer 1 as shown in FIG. 2. The handle 3 comprises an air intake 4 at an end of the handle 3 opposite the body 2. A motor 5 is located within the handle 3 such that it is positioned next to, or at least close to, the air intake 4. A filter or other filtering means (not shown) may be provided at the air intake 4, or between the air intake 4 and the motor 5, to prevent foreign objects which may be entrained in the airflow, such as hair or dust, from entering the motor 5.

During use, the motor 5 generates an airflow through the hair dryer 1. The motor 5 draws air into the handle 3 through the air intake 4. Air then passes through the motor 5 and from the handle 3 into the body 2 where is directed towards an air outlet 6. A heater (not shown), for example in the form of one or more heating elements, may be provided in the hair dryer 1 to heat the air prior to it being expelled from the air outlet 6.

A hair dryer 1 is shown as an example in FIGS. 1 and 2, however the motor 5 could be used in other handheld products that require the generation of an airflow. For example, the motor 5 could be included in a different hair care appliance: for instance a hot styling brush.

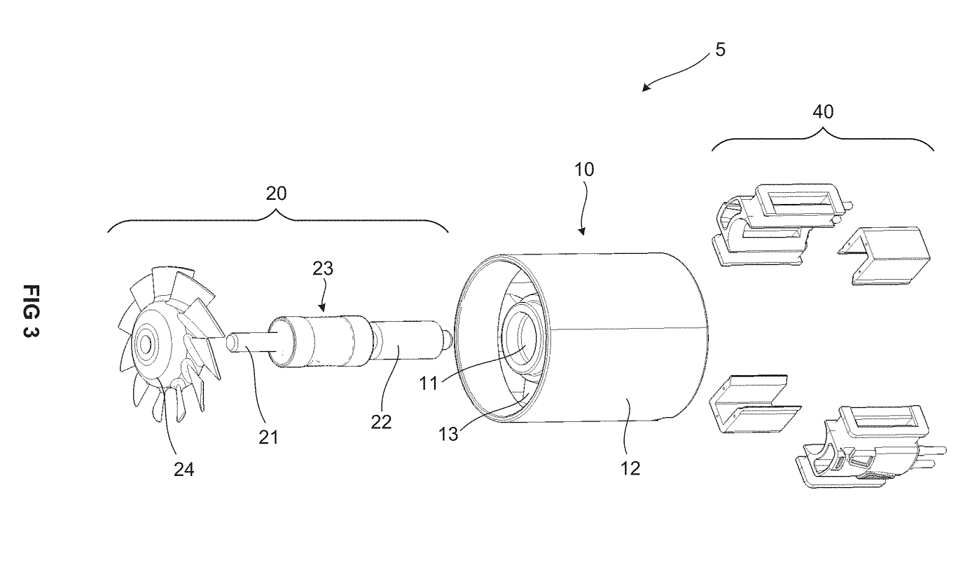

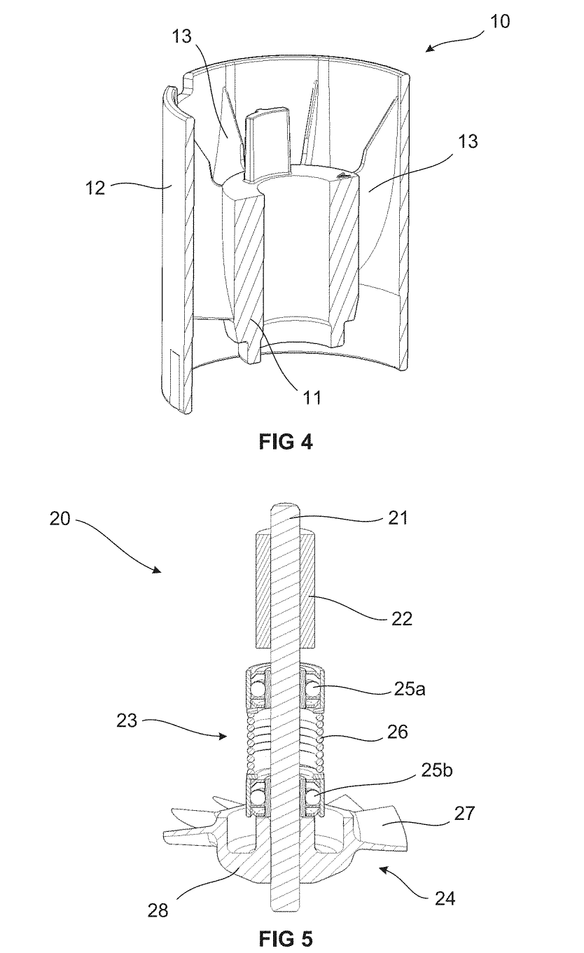

FIG. 3 is an exploded perspective view of the motor 5. The motor 5 comprises a frame 10, a rotor assembly 20 and a stator assembly 40. A cross section through the frame 10 is shown in FIG. 4. The frame 10 comprises an inner wall 11 and an outer wall 12. A number of diffuser vanes 13 extend between the inner wall 11 and the outer wall 12. The frame 10 is formed of zinc and can be formed, for example, by machining or die-casting, or a combination of both machining and die-casting. Zinc is an acoustically dull material and so the frame 10 is able to effectively absorb acoustic frequencies generated by the motor 5 during use. The zinc frame 10 therefore acts to reduce the overall level of noise generated by the product 1 during use.

The rotor assembly 20 comprises a shaft 21, a magnet 22, a bearing assembly 23 and an impeller 24. A cross-section through the rotor assembly 20 is shown in FIG. 5. The magnet 22, bearing assembly 23 and impeller 24 are all fixed directly to the shaft 21 by one or a combination of an interference fit and adhesive. The magnet 22 is a bonded permanent magnet of the sort typically used in permanent magnet brushless motors. In the example shown, the magnet 22 is a four-pole permanent magnet. The bearing assembly 23 comprises a pair of bearings 25a, 25b and a spring 26 separating the bearings 25a, 25b. The spring 26 acts to pre-load each of the outer races of the bearings 25a, 25b to reduce wear of the bearings during use. Once the rotor assembly 20 is assembled into the frame 10, the inner wall 11 of the frame 10 acts as a protective sleeve around the bearing assembly 23. The outer races of the bearings 25 are fixed to the inside circumference of the inner wall 11 by adhesive.

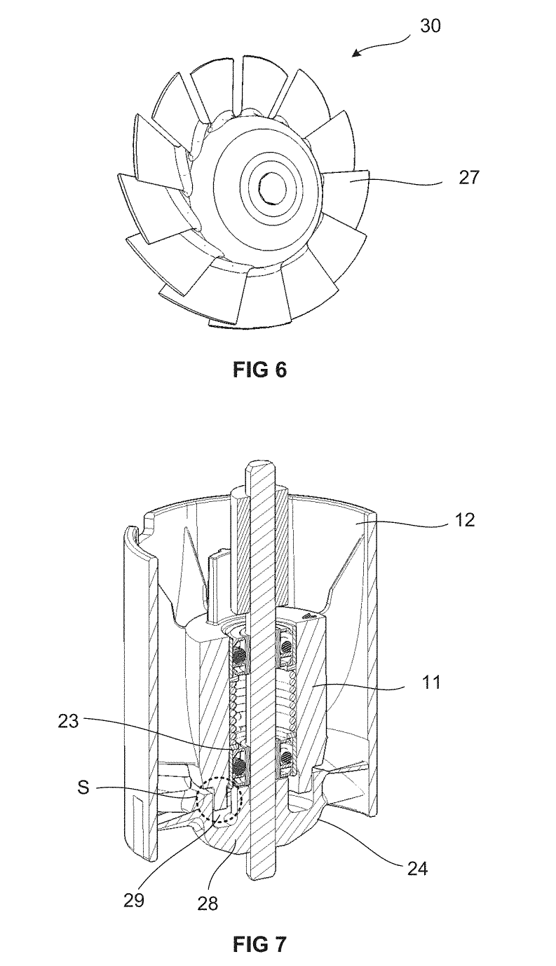

The impeller 24 shown in the Figures is an axial impeller with a plurality of blades 27 spaced circumferentially around, and extending radially out from, a central hub 28. During use, as each blade 27 spins, it creates sound waves at a specific frequency. It is therefore possible to design the impeller in such a way as to reduce its acoustic impact. The impeller 24 shown in FIGS. 3 and 5 comprises eleven blades. However, the number of blades 27 may differ according to the acoustic requirements of the motor 5 and/or handheld product. For example, an impeller 30 with thirteen blades 27 is shown in FIG. 6. During use, due to the higher number of smaller blades 27, the impeller 30 of FIG. 6 may generate an acoustic tone that has a higher frequency than the impeller 24 of FIG. 3 that has only eleven blades 27. At the expected operating speeds for the motor 5, the frequency of the tone generated by an impeller 30 with thirteen blades 27 is high enough so as to be outside the typical hearing range of a human. This reduces the acoustic impact of the motor 5 and goes even further to reduce the overall noise generated by the product, i.e. the hair dryer 1, during use.

The impeller 24, 30 is formed by machining aluminium. Aluminium is a very light material and therefore by using it to form the impeller 24, 30 this helps to counteract some of the additional weight included in the motor 5 by using zinc to create the frame 10. When used in a handheld product such as the hair dryer 1 of FIGS. 1 and 2, or another hair care product, the motor 5 will typically be run at rotational speeds of around 75 to 110 krpm. The magnitude of the forces acting on the impeller 24, 30 at these high speeds are very great. Thankfully, despite being light, aluminium is also very strong and so the impeller 24, 30 is capable of withstanding the large forces subjected to it when it rotates at high speed.

FIG. 5 shows that the hub 28 of the impeller 24 comprises a recess 29 in the downstream side of the hub. By having a recess 29, this further decreases the weight of the impeller 24, 30, which counteracts even more of the weight added by using zinc to form the frame 10. In addition, the recess 29 is annular and provides a cavity into which an axially extending portion or protrusion of the inner wall of the frame can extend. This creates a labyrinth seal inside the hub 28 of the impeller 24 which prevents foreign objects, such as hair and dust, from entering into the bearing assembly 23 which could damage the rotor assembly and significantly reduce the lifetime of the motor. The labyrinth seal can be seen in FIG. 7 which shows a cross section through the assembled frame 10 and rotor assembly 20. The labyrinth seal is highlighted at area S. FIG. 7 shows how the inner wall 11 of the frame 10 acts as a protective sleeve around the bearing assembly 23, as previously described.

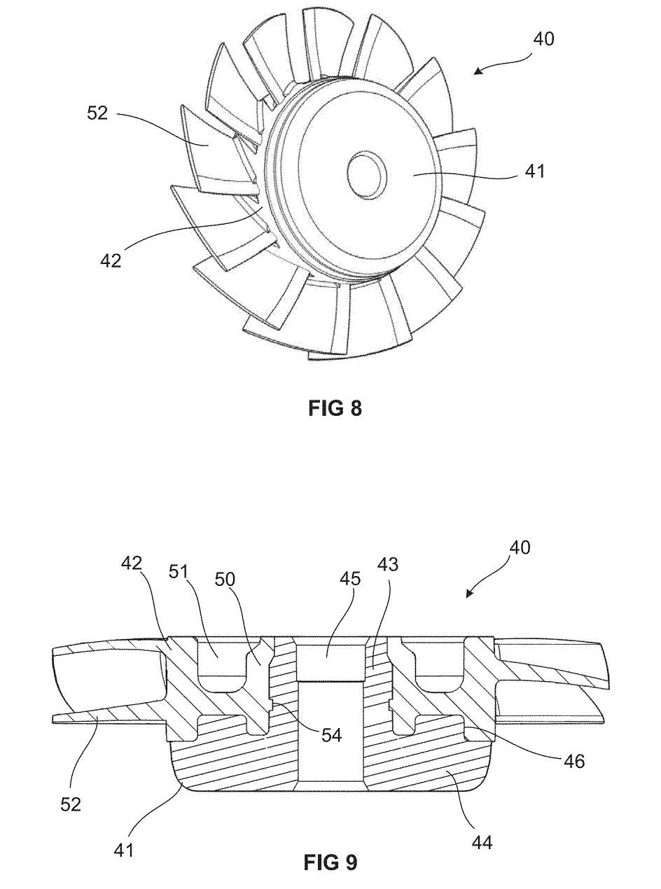

FIG. 8 shows an alternative impeller 40 for a motor according to embodiments of the disclosure. A cross section of the impeller 40 is shown in FIG. 9. The impeller 40 comprises a metal hub 41, preferably formed of brass, and an outer portion 42 that is formed of plastic or carbon fibre composite. The metal hub 41 includes a generally cylindrical portion 43 and a generally disc-shaped portion 44 located at one end of the cylindrical portion 43, the disc-shaped portion 44 having a larger radius than the cylindrical portion 43. A bore 45 extends through the metal hub 41 along the axis of rotation of the impeller 40 for accepting a rotor shaft such as the shaft 21 shown in FIGS. 3 and 5.

The metal hub 41 also includes an annular protrusion 46 that is located on the upper surface of the disc-shaped portion 44 as shown in FIG. 9. The protrusion 46 protrudes in the axial direction. The outer portion 42 may be formed or placed around the protrusion 46 and/or the upper surface of the disc-shaped portion 44.

The outer portion 42 includes an outer hub 50 that radially surrounds the cylindrical portion 43 of the metal hub 41. The outer portion 42 includes a recess 51 that is similar to and serves a similar function to the recess 29 of the impeller 24 shown in FIGS. 5 and 7. The outer portion 42 also includes a plurality of blades 52. In the example impeller 40 shown, there are thirteen blades.

The generally cylindrical portion 43 of the metal hub 41 includes an annular notch or groove 54. A part of the outer portion 42 projects into the groove 54. This arrangement may help to prevent axial slippage of the outer portion 42 on the metal hub 41.

The configuration of the impeller shown, having a metal hub 41 of relatively higher density and mass and an outer portion 42 and blades 52 of relatively lower density and mass, has the effect of concentrating the mass of the impeller 40 towards the centre and rotational axis of the impeller 40. As a result, the effects of any imbalances in the mass distribution of the impeller around the rotational axis can be reduced. The size and mass of the metal hub 41 and/or the outer portion 42 can be tuned such that the mass and/or moment of inertia of the impeller 40 is similar to that of the impeller 24 shown in FIGS. 3, 5 and 7. As a result, the impeller 40 can be a direct replacement of the impeller 24 such that it may rotate at a similar speed to the impeller 24 under similar conditions and similar motor input power. However, in some embodiments the mass and/or moment of inertia may be tuned to allow the impeller 40 to rotate slightly faster, to counteract the additional flexibility of the plastic or carbon fibre composite blades compared to the aluminium blades of the impeller 24 and to ensure a similar level of airflow through the motor. For example, where the impeller 24 rotates at 110 krpm, the impeller 40 may rotate at 120 krpm or higher, in some embodiments.

The impeller 40 may rotate at high speeds in use, such as 100 krpm or higher. The relatively flexible outer portion 42 may tend to expand at these high speeds, potentially causing the capability of torque transfer from the metal hub 41 to the outer portion 42 to be reduced. To counteract this, the presence of the annular shaped axial protrusion 46 may increase the surface area of contact between the metal hub 41 and outer portion 42. Additionally, a part of the outer portion 42 is contained within the radius of the annular protrusion 46, and hence at high rotation speeds the expansion of this part is constrained. Moreover, at high rotation speeds, the metal hub 41 may tend to radially expand less than the relatively more flexible outer portion 42. As a result, the expansion of the outer portion 41 may cause the annular protrusion 46 and the part of the outer portion 42 contained therein to be pushed together, increasing the frictional force between them and ensuring torque transfer even at very high speeds. However, at low speeds or when the impeller is stationary, there may need to be some residual friction between the metal hub 41 and outer portion 42 to transmit torque, in the absence of any other means of fixing the two parts together such as adhesive.

In some embodiments, where the metal hub 41 and outer portion 42 are bonded together using adhesive, the presence of the axial protrusion 46 may increase the surface area of bonding, and may also ensure that the bond is less likely to fail over time due to the tendency for part of the outer portion 42 to be pushed onto the protrusion 46 at high speeds.

The impeller 40 may be formed in a number of ways. In one example, the metal hub 41 is formed, followed by overmoulding the outer portion 42 directly onto the metal hub 41. In other examples, the metal hub 41 and outer portion 42 may be formed separately and then brought together. The two components may be fixed together using a press fit and/or may also be bonded together using adhesive.

Whilst particular embodiments have thus far been described, it will be understood that various modifications may be made without departing from the scope of the disclosure as defined by the claims.

1. A motor comprising:
a frame for supporting a rotor assembly and a stator assembly, the frame comprising an inner wall and an outer wall and a plurality of diffuser vanes extending between the inner wall and outer wall;
a rotor assembly comprising a shaft, a magnet, a bearing assembly and an impeller; and
a stator assembly comprising a bobbin, a stator core and a winding wound round the bobbin;
the impeller comprising a metal hub and an outer portion, the outer portion comprising a plurality of blades and being formed of plastic or carbon fibre composite.

2. The motor of claim 1, wherein the metal hub includes a cylindrical portion.

3. The motor of claim 2, wherein the metal hub includes a portion of greater radius than the cylindrical portion.

4. The motor of claim 3, wherein the portion of greater radius is disc-shaped.

5. The motor of claim 3, wherein the portion of greater radius includes an axial protrusion.

6. The motor of claim 5, wherein the axial protrusion is annulus-shaped.

7. The motor of claim 1, wherein the outer portion includes an outer hub that radially surrounds at least part of the metal hub.

8. The motor of claim 1, wherein the impeller is an axial impeller.

9. The motor of claim 1, wherein the frame is formed from zinc by one or a combination of die-casting and machining.

10. The motor of claim 1, wherein the metal hub is formed of brass.

11. The motor of claim 1, wherein the outer portion is overmoulded onto the metal hub.

12. The motor of claim 1, wherein the impeller comprises 13 blades.

13. The motor of claim 1, wherein, during use, the rotor spins at a speed of between 50 and 120 krpm to generate airflow through the product.

14. The motor of claim 1, wherein the metal hub includes at least one notch into which a part of the outer portion protrudes so as to inhibit axial movement of the outer portion relative to the metal hub.

15. A handheld product comprising a motor as claimed in claim 1 for generating an airflow through the product.

16. The handheld product of claim 15, wherein the handheld product is a hair care appliance.

17. An impeller for a motor, the impeller comprising a metal hub and an outer portion, the outer portion comprising a plurality of blades and being formed of plastic or carbon fibre composite.
